(19) United States
(12) Patent Application Publication
(10) Pub. No.: US 2007/0057531 A1
(43) Pub. Date: Mar. 15, 2007

(54) ROOF ASSEMBLY FOR A VEHICLE HAVING AN OPEN BODY

(75) Inventors: Jan Hesse, Bietigheim-Bissingen (DE); Marcus Papendorf, Besigheim (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/531,209

(22) Filed: Sep. 12, 2006

(30) Foreign Application Priority Data
Sep. 12, 2005 (DE) 10 2005 043 509.2

(51) Int. Cl. B60J 7/00

(52) U.S. Cl. 296/107.17

(57) ABSTRACT

A roof assembly for a vehicle having a steep-back design with an open body includes a roof having roof parts. A rod kinematic system is connected to the roof parts to move, upon actuation, the roof parts between a closed position of the roof in which the roof parts adjoin one another along a planar level to thereby cover the vehicle interior and a stored position of the roof in which the roof parts stack on top of one another to thereby expose the vehicle interior. The rod kinematic system connects one of the roof parts to a supporting base. An actuator is coupled to the rod kinematic system to actuate the rod kinematic system. A support is on one of the roof parts. The actuator is mounted on the support.

### CROSS-REFERENCE TO RELATED APPLICATIONS

This application claims foreign priority benefits under 35 U.S.C. § 119(a)-(d) to DE 10 2005 043 509.2, filed Sep. 12, 2005, which is hereby incorporated by reference in its entirety.

### BACKGROUND OF THE INVENTION

1. Field of the Invention

The present invention relates to a roof for a vehicle having an open body.

2. Background Art

U.S. Pat. No. 2,704,225 describes a four-part openable roof. The roof includes overlapping shell-like curved roof parts. The roof parts adjoin one another when the roof is closed. To open the roof, the roof parts are brought together to the rear and stored as a package in the trunk area of the vehicle. In the roof part package, the roof parts lie in the same sequence and are layered above the farthest rear roof part such that the farthest front roof part lies on top in the roof part package. The roof parts are mutually borne and drive-connected by four-bar kinematic linkages. The farthest rear roof part is supported against the vehicle body as a base by an additional four-bar kinematic linkage. Starting from the drive rod for the four-bar kinematic linkage connecting the farthest rear roof part to the roof part lying in front of the farthest rear roof part, the four-bar kinematic linkages situated between the roof parts are respectively connected and driven by coupling rods. For this purpose, the drive rod for the four-bar kinematic linkage between the farthest rear roof part and the roof part in front of farthest rear roof part is a two-armed lever. One lever arm is linked to the base. The other lever arm is situated on the other side of the linkage of the drive rod to the farthest rear roof part and is connected to a coupler. The coupler connects the farthest rear roof part to the roof part in front of the farthest rear roof part. The drive rod for the four-bar kinematic linkage associated with the farthest rear roof part is acted upon by an actuator. The actuator is formed by an actuating cylinder and is supported against the base. In this manner, the bearing and guiding support as well as the support of the drive are achieved for the entire roof against the base.

U.S. Pat. No. 2,812,975 describes a roof having three roof parts. Each roof part has an overlapping shell-like shape. The roof parts as a whole are transferred from their closed position, extending in the direction of forward vehicle travel, to a raised open position by swiveling the rear roof part about a transverse axis fixed to the vehicle. For this swivel motion an independent actuator is associated with the rear roof part. The front roof parts adjoin the rear roof part. The roof parts are mutually connected to an independent actuator via rod kinematic systems. In the upright position of the roof raised by swiveling of the rear roof part, the roof parts adjoining the rear roof part are swivelled underneath the rear roof part, corresponding to their sequence of connection to the rear roof part, resulting in a roof part package in the stored position in which the rear roof part and the farthest front roof part front form the outer roof parts of the roof stack, with equal cambering of the roof parts.

U.S. Pat. No. 2,623,779 describes a roof having roof parts movable in the longitudinal direction of the roof in a mutually displaceable manner by a telescoping cylinder. The rear roof part together with the telescoping cylinder may be swivelled about a horizontal transverse axis into the stored position for the roof, with the front roof parts inserted under the rear roof part.

### SUMMARY OF THE INVENTION

An object of the present invention is to provide a vehicle having an open body with respect to its roof design such that when the roof is closed a flat roof structure results which, with regard to multipart roofs having an essentially flat roof plane in the closed position, is of particular importance for vehicles which as steep-back vehicles have a roof opening that is open to the rear and adjacent to a rear opening, and which by exposing the roof opening may be used as vehicles having an open body.

In carrying out the above object and other objects, the present invention provides a roof assembly for a vehicle. The roof assembly includes a roof having roof parts. A rod kinematic system is connected to the roof parts to move, upon actuation, the roof parts between a closed position of the roof in which the roof parts adjoin one another along a planar level to thereby cover the vehicle interior and a stored position of the roof in which the roof parts stack on top of one another to thereby expose the vehicle interior. The rod kinematic system connects one of the roof parts to a supporting base. An actuator is coupled to the rod kinematic system to actuate the rod kinematic system. A support is on one of the roof parts. The actuator is mounted on the support.

In accordance with an embodiment of the present invention, oppositely situated support of the actuator for coupling the actuator to the drive-connected rod kinematic system is provided on the roof side, in particular on a roof part. In this manner, an actuator such as a linear actuator in the form of an actuating cylinder which extends essentially along a roof part may be used irrespective of the fact that the adjustment of the roof parts with respect to one another as well as the adjustment of the entire roof with respect to the supporting base is performed by this common actuator. In addition, as a result of this design the roof becomes a self-contained assembly unit in which the roof need only be connected to the supporting base by a rod kinematic system associated with a roof part. This supporting base may be stationary or movable, for example in the form of an adjustment bracket or a rotary guide rod. This opens up additional possibilities for transferring the roof into desired stored positions.

Within the scope of the present invention, the rod kinematic systems may preferably be designed as four-bar kinematic linkages. As a result, a simple structure is obtained which offers advantageous possibilities for adjusting the roof parts with respect to one another so as to form a roof part package. In the roof part package, the roof parts are layered on top of one another. This is optionally accomplished with package formation at different heights as a result of the four-bar kinematic linkage provided for the supporting base.

With regard to a compact layering of the roof parts while maintaining the alignment of the roof parts with respect to one another, it is practical to provide a five-bar kinematic linkage in the drive transmission between rod kinematic systems associated with consecutively positioned roof parts. This enables swivel paths in the range of 180°. As such, an essentially direct mutual positioning of roof parts swivelled in over one another is achieved.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a vehicle roof in accordance with an embodiment of the present invention, the roof having three roof parts mutually supported and adjustable with respect to one another by a rod kinematic system between a closed position in which the roof parts are consecutively positioned and form an essentially planar roof level and a stored (stowed or opened) in which the roof parts are stacked on top of one another, the rear roof part being supported against a supporting base by a rod kinematic system and as the supporting base a rotary guide rod assembly is provided which may be moved with respect to the vehicle body having an opening which accommodates the roof in its closed position;

FIG. 2 illustrates the roof in an intermediate position during its transfer from the closed position to the stored position with the mutual support of the roof parts with respect to one another by the rod kinematic system and the support of the rear roof part to the rotary guide roof assembly being shown;

FIG. 3 illustrates the roof in a transition position in which the roof parts meet to form a roof part stack situated at the roof level during its transfer from the intermediate position to the stored position;

FIG. 4 illustrates the roof in the stored position in which the roof part stack is swivelled to an upside-down position; and

FIGS. 5, 6, 7, and 8 illustrate schematic illustrations of the roof for explaining the roof design, based on the illustration of only two roof parts, one of which as a rear roof part is connected to the supporting base, once again starting from an illustration of the roof when the roof is closed (FIG. 5), through transitional positions to the illustration of the roof as a brought-together roof part package (FIG. 8).

### DETAILED DESCRIPTION OF THE PREFERRED EMBODIMENT(S)

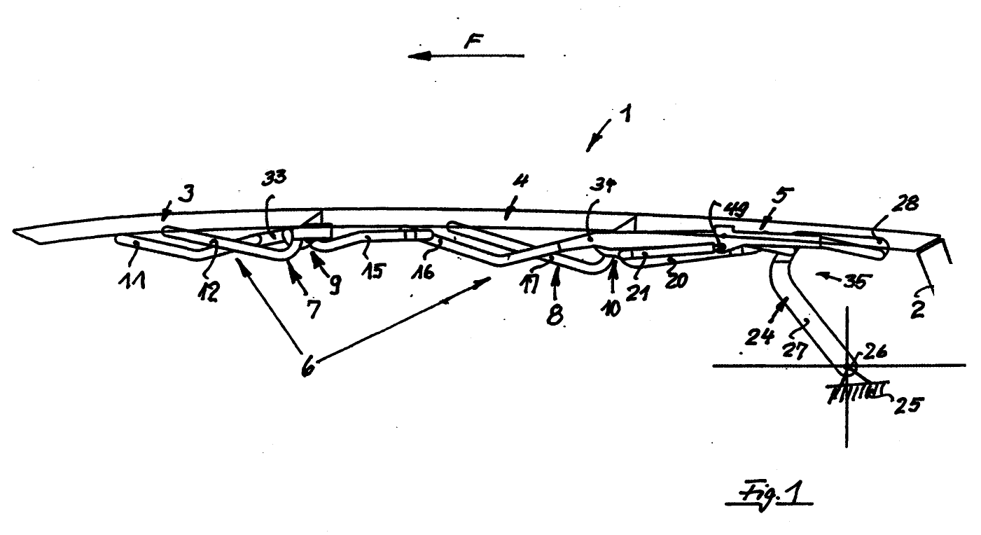

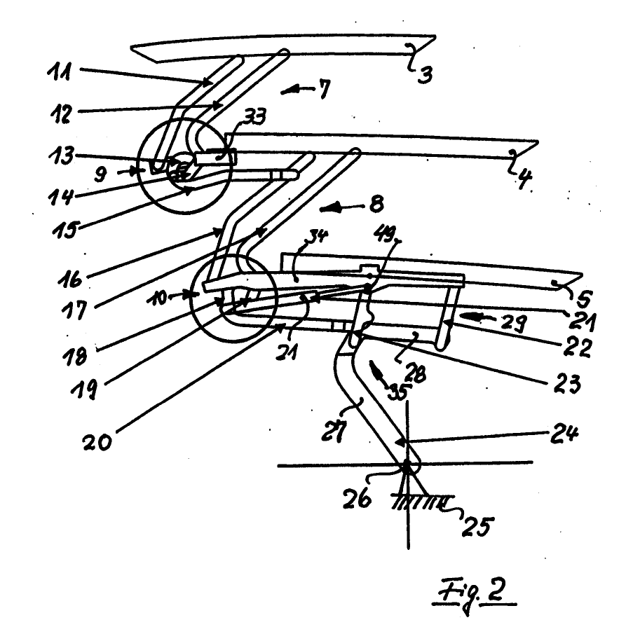

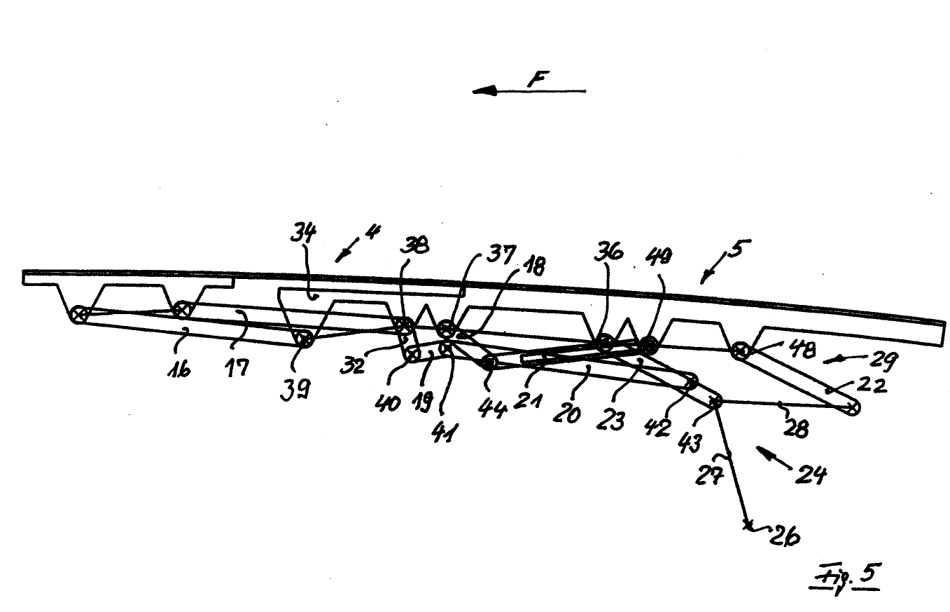

Referring now to the figures, a vehicle roof 1 in accordance with an embodiment of the present invention is shown. Roof 1 includes a plurality of dimensionally stable roof parts. In the illustrated embodiment, roof 1 includes a front roof part 3, a center roof part 4, and a rear roof part 5. In other embodiments, roof 1 includes just two roof parts or includes more than three roof parts. Roof 1 is movable between a closed position in which roof parts 3, 4, 5 cover the interior of a vehicle having an open body and a stored (stowed or opened) position in which the roof parts are stacked on top of one another and stored in a storage area of the vehicle thereby exposing the vehicle interior. In the closed position of roof 1, the roof is substantially planar with roof parts 3, 4, 5 being consecutively positioned and adjoining one another as shown in FIG. 1. In the stored position of roof 1, the roof is stacked with roof parts 3, 4, 5 lying one on top of the other in a layered manner with rear roof part 5 situated above center roof part 4 and center roof part 4 situated above front roof part 3 as shown in FIG. 4.

The vehicle includes a vehicle body schematically indicated by reference numeral 25. The vehicle is a steep-back vehicle having a roof opening that is open to the rear, to which a rear body opening that is closeable by a tailgate or a rear door 2 corresponds. Roof 1 has a roof recess open towards the rear which corresponds to a recess in rear vehicle body 25. The recess in rear vehicle body 25 is closable by tailgate or rear hatch 2 at the back side. Tailgate or rear hatch 2 adjoins roof 1 at the back side.

Irrespective of the description and explanation as a roof 1 having three roof parts 3, 4, 5, in accordance with the present invention a roof may have only two or more than three roof parts.

A rod kinematic system 6 mutually supports roof parts 3, 4, 5. Rod kinematic system 6 connects to roof parts 3, 4, 5 to move the roof parts between the closed and stored positions of roof 1. Rod kinematic system 6 includes a first guide rod assembly 7 and a second guide rod assembly 8. First guide rod assembly 7 supports front and center roof parts 3, 4. Second guide rod assembly 8 supports center and rear roof parts 4, 5. First and second guide rod assemblies 7, 8 are formed by respective four-bar kinematic linkages.

A first five-bar kinematic linkage 9 is situated as the drive connection for the first guide rod assembly 7. A second five-bar kinematic linkage 10 is situated as the drive connection for the second guide rod assembly 8. First guide rod assembly 7 with first five-bar linkage 9 and second guide rod assembly 8 with second five-bar linkage 10 movably adjust roof parts 3, 4, 5 between the closed position of roof 1 in which roof parts 3, 4, 5 are extended in a plane over the vehicle interior and the stored position of roof 1 in which roof parts 3, 4, 5 are stacked and layered on top of one another. In the stored position of roof 1, roof parts 3, 4, 5 are layered on top of one another with a small distance therebetween to form a compact roof part package 31 despite an essentially complete coverage in the longitudinal direction.

First guide rod assembly 7 (i.e., first rod kinematic system) between roof parts 3, 4 includes a first control rod 11 and a first main guide rod 12. First five-bar linkage 9 is situated in the drive of first guide rod assembly 7 to provide drive action on first guide rod 12 via a first coupling rod 15.

Second guide rod assembly 8 (i.e., second rod kinematic system) between roof parts 4, 5 includes a second control rod 16 and a second main guide rod 17. Second five-bar linkage 10 is situated in the drive of second guide rod assembly 8 to provide drive action on second guide rod 17 via a second coupling rod 20.

First coupling rod 15, starting from a linkage to second control rod 16 of second guide rod assembly 8, is connected via first five-bar linkage 9 to first guide rod 12. First five-bar linkage 9 includes a first pendulum rod 13 and a first tension rod 14. First pendulum rod 13 is situated in front of first tension rod 14 as seen in the direction of vehicle forward travel F. First pendulum rod 13, together with first control rod 11 and first guide rod 12, is linked to a first bracket 33. First bracket 33 is attached to center roof part 4 and projects forward with respect to center roof part 4. First pendulum rod 13 is also linked to first coupling rod 15. First tension rod 14 has an offset linkage with respect to first coupling rod 15 in the direction opposite the direction of travel F for linking first pendulum rod 13. First tension rod 14 is further linked to an extension (drive arm) of first guide rod 12 projecting beyond the linkage between first guide rod 12 and first bracket 33. As a result, the drive action for first guide rod assembly 7 is achieved via first five-bar linkage 9.

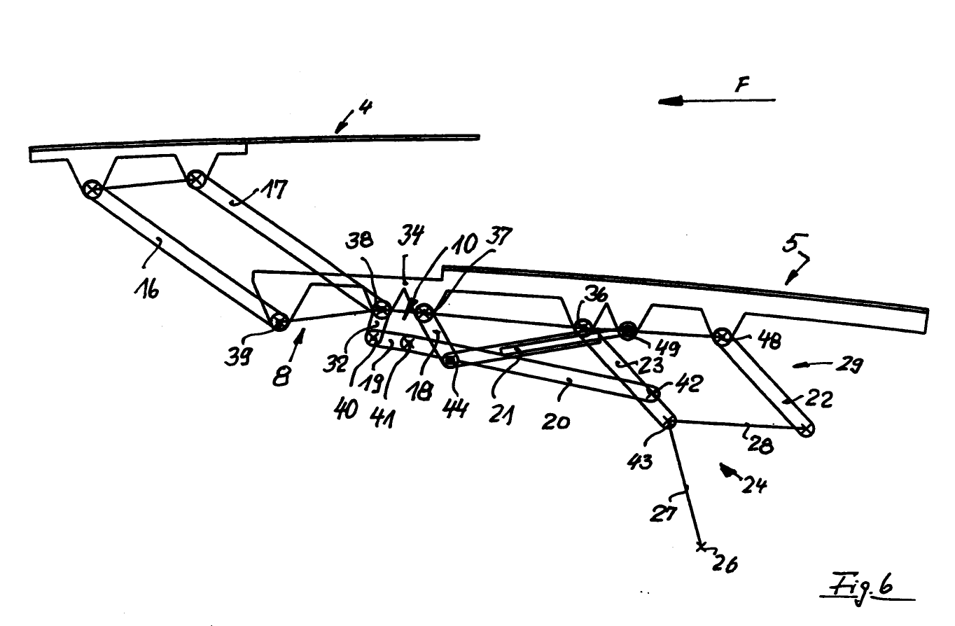

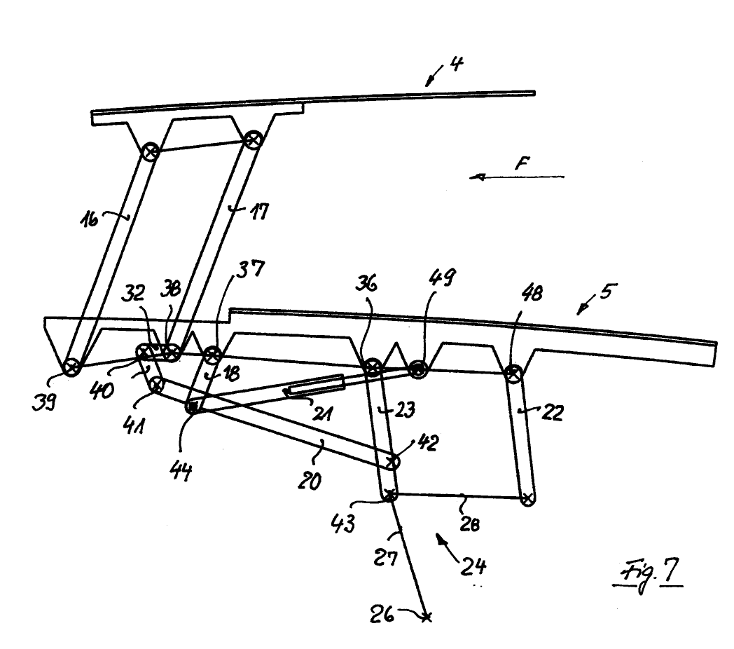

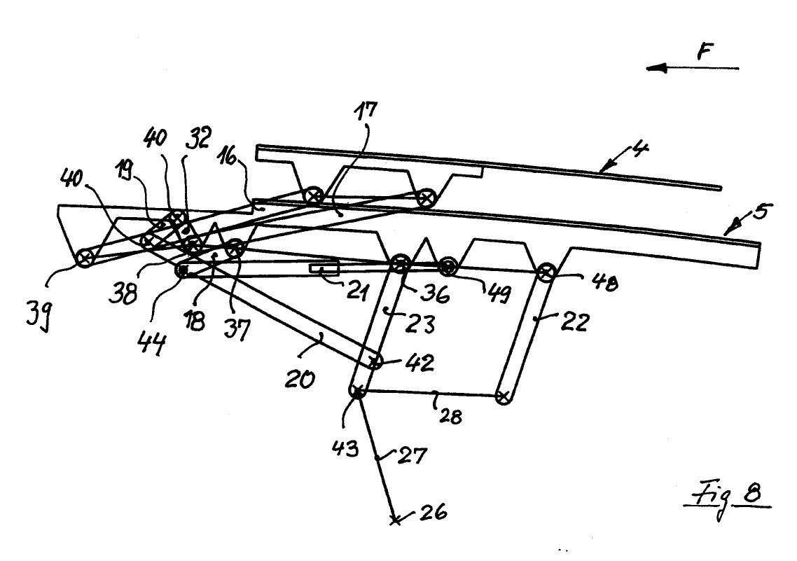

In a corresponding manner, the drive action for second guide rod assembly 8 is achieved via second five-bar linkage 10. To this end, second coupling rod 20 is connected via second five-bar linkage 10 to second guide rod 17. Second five-bar linkage 10 includes a second pendulum rod 18 and a second tension rod 19. Second pendulum rod 18 is situated in front of second tension rod 19 as seen in the direction of vehicle forward travel F. Second pendulum rod 18, together with second control rod 16 and second guide rod 17, is linked to a second bracket 34. Second bracket 34 is attached to rear roof part 5 and projects forward with respect to rear roof part 5. Second pendulum rod 18 is also linked to second coupling rod 20. Second tension rod 19 is linked to an extension (drive arm 32 denoted in FIGS. 5, 6, 7, and 8) of second guide rod 17 projecting beyond the linkage between second guide rod 17 and second bracket 34. As a result, the drive action for second guide rod assembly 8 is achieved via second five-bar linkage 10 is illustrated in greater detail with reference to FIGS. 5, 6, 7, and 8 for five-bar kinematic linkage 10 between rear roof part 5 and center roof part 4.

A rotary guide rod 24 connects rear roof part 5 to vehicle body 25. In the illustrated embodiment, rotary guide rod 24 includes a first leg 27 connected at one end to vehicle body 25 such that the rotary guide rod is rotatable about a rotational axis 26, which is stationary with respect to vehicle body 25. In the closed position of roof 1 (as shown in FIG. 1), first leg 27 rises forward at an angle in the direction of travel F and a second leg 28 of rotary guide rod 24 extends backward and is situated at an angle with respect to first leg 27. Second leg 28 forms a supporting base 35 for a third guide rod assembly 29 (i.e., third rod kinematic system) by which rear roof part 5 is connected to rotary guide rod 24.

Third guide rod assembly 29 is formed by a four-bar kinematic linkage. Third guide rod assembly 29 includes a third main guide rod 22 and a third control rod 23. Third guide rod 22 and third control rod 23 have respective linkage points at one end to second leg 28 of rotary guide rod 24 as a supporting base. Likewise, third guide rod 22 and third control rod 23 have respective linkage points at their other end to rear roof part 5 which runs in second bracket 34 in the direction of forward vehicle travel F (i.e., towards its front) to which second control rod 16 and second guide rod 17 of second guide rod assembly 8 are linked. As a result, roof parts 3, 4, 5, move relative to rotary guide rod 24 as a supporting base 35 in response to retraction and extension of a drive cylinder 21, which acts as an actuator.

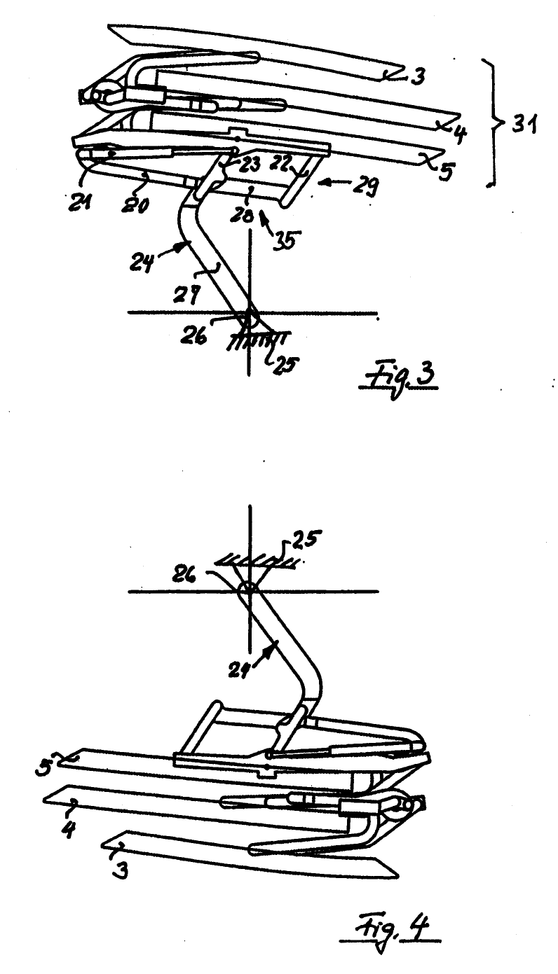

Roof parts 3, 4, 5, together with rod kinematic systems 7, 8, are shown in the brought-together stacked position in FIGS. 3 and 4. FIG. 3 illustrates roof part package 31 brought together to the rear in the end position of the opening of the roof, it being possible to swivel the roof part package downward by rotary guide rod assembly 24 into an upside-down position which forms a stored position. To illustrate the structure of five-bar kinematic linkages 9, 10, rear roof part 5 and front roof part 4 together with rotary guide rod assembly 24 are schematically shown in isolated illustrations in FIGS. 5, 6, 7, and 8. The same reference numerals are used to denote the individual parts.

FIGS. 5, 6, 7, and 8 illustrate in particular the position of the linkages of second and third guide rod assemblies 8, 29 with respect to rear roof part 5 and second bracket 34 thereof. In the covered region of rear roof part 5, the sequential listing of consecutive parts in the direction of forward vehicle travel F is as follows: linkage 48 for third main guide rod 22, linkage 49 for actuating cylinder 21, and linkage 36 for third control rod 23. Further forward in the direction of travel F, in particular in the region of second bracket 34, the sequence continues with linkage 37 for second pendulum rod 18, linkage 38 for second main guide rod 17, and linkage 39 for second control rod 16, wherein roof 1 is closed and roof parts 4 and 5 adjoin one another. Drive arm 32 is associated with second guide rod 17 and has a linkage 38 to second guide rod 17 and a linkage 40 to second tension rod 19. Drive arm 32 lies on a straight line running at a small angle downward and to the rear. For second tension rod 19, still with reference to the closed position of roof 1, the straight line defined by linkage point 40 to drive arm 32 and linkage point 41 to second coupling rod 20 specifies an extension essentially in the longitudinal direction of the roof with a slight inclination upward and to the rear. Therefore, is at a shallow angle with respect to second coupling rod 20. Second coupling rod 20 is inclined slightly downward and to the rear. As such, when viewed as a whole when roof 1 is closed, second tension rod 19 and second coupling rod 20 run in approximate alignment with one another.

Linkage 42 of second coupling rod 20 to third control rod 23 occurs in the region of the third control rod which runs into linkage 43 to leg 28 of rotary guide rod assembly 24. Leg 28 for extension of roof 1 running essentially in parallel. Third guide rod 22 and third control rod 23 for third rod kinematic system 29 forming a rod parallelogram in the direction of travel F, running obliquely upward and forward at an acute angle preferably between approximately 20° and 30°. With reference to closed roof 1, second pendulum rod 18 extends from its roof-side linkage 37 toward actuating cylinder 21, obliquely downward and to the rear, and therefore in an opposite direction with respect to actuating cylinder 21. The common linkage of actuating cylinder 21 to second pendulum rod 18 and to second coupling rod 20 is denoted by reference numeral 44. Second pendulum rod 18 and actuating cylinder 21 form the legs of a triangle. The base of the triangle is defined linkages 37 and 49 and is on the roof side. The triangle legs define an obtuse angle of approximately 130° and intersect below roof 1 in the apex formed by linkage 44.

With reference to closed roof 1, a flat structure thus results since second control rod 16 and second guide rod 17 for second rod kinematic system 8 are in essence consecutively aligned. First rod kinematic system 7 and first five-bar kinematic linkage 9 situated in the drive thereof have essentially the same spatial relationships as for second rod kinematic system 8 and second five-bar kinematic linkage 10. The difference is linkage of first coupling rod 15 to second control rod 16 near the linkage of the second control rod on the roof side, as shown in FIG. 1, which likewise contributes to a flat roof structure.

A roof design for a steep-back vehicle having an open body provides a multi-level openable roof 1 whose roof parts 3, 4, 5, which are mutually connected by first and second rod kinematic systems 7, 8 and adjustable with respect to one another, are supported on a supporting base 35 by third rod kinematic system 29. Third rod kinematic system 29 is associated with rear roof part 5. A common actuator is provided for adjusting roof parts 3, 4, 5 with respect to one another and with respect to supporting base 35, and this common actuator is situated between one of the rod kinematic systems and a support on the roof side.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A roof assembly for a vehicle, the roof assembly comprising:
a roof having a plurality of roof parts;
a supporting base;
a rod kinematic system connected to the roof parts to move, upon actuation, the roof parts between a closed position of the roof in which the roof parts adjoin one another along a planar level to thereby cover the vehicle interior and a stored position of the roof in which the roof parts stack on top of one another to thereby expose the vehicle interior, wherein rod kinematic system connects one of the roof parts to the supporting base;
an actuator coupled to the rod kinematic system to actuate the rod kinematic system; and
a support on one of the roof parts, wherein the actuator is mounted on the support.

2. The roof assembly of claim 1 wherein:
the roof parts include a front roof part, a center roof part, and a rear roof part;
wherein the support for the actuator is on the rear roof part.

3. The roof assembly of claim 2 wherein:
the actuator is a linear actuating cylinder.

4. The roof assembly of claim 2 wherein:
the one of the roof parts connected to the supporting base is the rear roof part.

5. The roof assembly of claim 4 wherein:
the rod kinematic system includes first, second, and third guide rod assemblies for moving the roof parts between the closed and stored positions of the roof;
wherein the first guide rod assembly is connected between the front and center roof parts, the second guide rod assembly is connected between the center and rear roof parts, and the third guide rod assembly is connected to the rear roof part.

6. The roof assembly of claim 5 wherein:
each guide rod assembly is a four-bar kinematic linkage.

7. The roof assembly of claim 6 wherein:
the second guide rod assembly includes a second coupling rod, wherein the actuator is coupled to the second coupling rod and the third guide rod assembly as a drive connection between the second and third guide rod assemblies.

8. The roof assembly of claim 7 wherein:
the first and second guide rod assemblies respectively include first and second five-bar kinematic linkages.

9. The roof assembly of claim 8 wherein:
the second coupling rod is guided by a second pendulum rod of the second five-bar kinematic linkage.

10. The roof assembly of claim 9 wherein:
the second five-bar kinematic linkage includes a second tension rod, wherein the second tension rod is linked to a drive arm of a first guide rod of the first guide rod assembly.

11. The roof assembly of claim 10 wherein:
linkages of the rod kinematic system for the front roof part and leading to the supporting base for the pendulum rod and for the actuator are associated with the rear roof part.

12. The roof assembly of claim 11 wherein:
linkages for the rod kinematic system leading to the front roof part and for the pendulum rod in the region of a forwardly projecting bracket for the rear roof part are provided by the linkages associated with the rear roof part.

13. The roof assembly of claim 12 wherein:
the linkages for the rod kinematic system leading to the supporting base and for the actuator are provided on the rear roof part overlapping same.

14. The roof assembly of claim 13 wherein:
the linkage for the actuator is situated on the rear roof part, between the linkages for the rod kinematic system leading to the supporting base.

15. The roof assembly of claim 10 wherein:
when the roof is closed, the coupler and the intermediate rod are aligned in essentially the same extension in the longitudinal direction of the roof.

16. The roof assembly of claim 10 wherein:
when the roof is closed, the pendulum rod and the actuator are situated with respect to one another at an obtuse angle which opens toward the rear roof part.

17. The roof assembly of claim 1 wherein:
the supporting base includes a rotary guide rod assembly by which the roof part package may be swivelably stored in an upside-down position in a floor region of a vehicle.

18. The roof assembly of claim 1 wherein the vehicle is steep-back vehicle, wherein
the roof in its closed position forms the cover for a roof opening which merges into a rear opening in the vehicle, a rear closure is associated therewith which adjoins the roof opening at the rear.
